(19) United States
(12) Patent Application Publication
(10) Pub. No.: US 2025/0177788 A1
(43) Pub. Date: Jun. 5, 2025

(54) SELF-RETRACTING DEVICE HARNESS TUNNEL ADAPTER

(71) Applicant: MSA TECHNOLOGY, LLC, Cranberry Township, PA (US)

(72) Inventors: Daniel Oppong Amankwah, Cranberry Township, PA (US); Loryn Ashley Bertoti, Pittsburgh, PA (US); Chris Sandberg, Pittsburgh, PA (US); Bryan Kroh, Harmony, PA (US)

(21) Appl. No.: 18/527,925

(22) Filed: Dec. 4, 2023

(51) Int. Cl. A62B 35/00; F16B 2/20

(52) U.S. Cl. CPC A62B 35/0037; F16B 2/20; A62B 35/0018

(57) ABSTRACT

An adapter includes an extending body adapted to maintain an open volume between two sections of the webbing extending between two spaced slots and an upper surface of a D-shim of a safety harness so that a section of a connector may be passed through the volume to removably connect the connector to the safety harness. The extending body of the adapter is formed separately from the D-shim and from a D-ring of the safety harness. The extending body is configured to be placed within a looped volume between the two sections of the webbing extending between the two spaced slots and an upper surface of the D-shim with the D-ring connected to the two sections of the webbing extending between the spaced slots.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Fall protection safety harnesses are often used as a component of a fall protection system for individuals in occupations or activities involving the potential for a fall from a height. As known in the fall protection devices, various connectors are operatively attached to safety harnesses for connection of various fall protection devices to the safety harness. A commonly used connector on safety harnesses is a D-ring. In recent years, fall protection devices such as self-retracting devices (SRDs), personal fall limiters (PFLs), and lanyards have been shifting to use of connectors which connect to the webbing of the safety harness in the vicinity of the D-ring but not via the D-ring. For example, one such connector is a relatively new style of connector, a pin or pin-style connector, in which a pin may, for example, slide or rotate/pivot between an open and a closed state. Other such connectors include carabiners, as known in the art, which may include curved members with articulating gates. A number of newer safety harnesses are equipped with a “PFL/SRD tunnel” which is a feature built or integrated into the D-shim of the safety harness that provides for a fairly simple and ready connection with such connectors.

Not all harnesses are equipped with a PFL/SRD tunnel. If a user has, for example, a PFL device (or lanyard) with a connector such as a pin connector or carabiner, the user must pull the dorsal webbing straps through the D-shim (via which a D-ring is connected to the safety harness) to create space for the connector. The user must then push a portion or section of the connector (while in its open state) behind the webbing and subsequently place the connector in its closed or engaged state. This process is arduous and time-consuming for users as a result of the fixed arrangement of the dorsal webbing through the D-shim. Friction between the web and the D-shim causes resistance as the user tries to pull slack to make room for the pin. The web routing gives the harness structure and strength (which is important to the operation thereof) but it makes the connector very cumbersome to attach. The process is particularly cumbersome to users who often disconnect and reconnect a PFL. In that regard, fall protection needs may change throughout the day. Additionally, users have been known to incorrectly attach a connector such as pin style connectors or carabiners directly to the D-ring of the harness, which is quick and convenient, but incorrect and potentially dangerous. In that regard, such connectors should always be placed behind the dorsal webbing of the safety harness.

### SUMMARY

Adapters hereof enable one to connect a connector to a safety harness. The connector is further adapted to connect a (fall protection safety) device to the safety harness. The connector is configured to be placed in an open state (for connection to the safety harness and connection to the device) or a closed state (for maintenance of connection to the safety harness and to the device). The safety harness includes webbing and a D-shim. The D-shim includes spaced slots through which each of two sections of the webbing pass (that is, are looped through). A D-ring is connected via a connector passage in the D-shim to the two sections of webbing passing between two of the spaced slots. The adapter includes an extending body adapted to maintain an open volume between the two sections of the webbing extending between the spaced slots and an upper surface of the D-shim so that the connector (that is, a section thereof) may be positioned within or passed through the volume to removably connect the connector to the safety harness. In that regard, when the connector is in an open state, a section of the connector may be passed through the open volume. Afterward the connector may be placed in the closed state. The extending body of the adapter is formed separately from the D-shim and from the D-ring. The extending body is configured to be placed (for example, slid) into a looped volume between the two sections of the webbing extending between the spaced slots and an upper surface of the D-shim with the D-ring connected to the two sections of the webbing extending between the spaced slots. The connector may, for example, be a pin-style connector or a carabiner.

In a number of embodiments, the extending body includes an extending base, an extending webbing support spaced from the extending base, and an intermediate member connected between the extending base and the extending webbing support. The intermediate member may, for example, divide the open volume into a first volume on a first side of the intermediate member and a second volume on a second side of the intermediate member when the adapter is connected to the safety harness. A portion of the D-ring may be positioned within the first volume. The connector may be passed through the second volume during connection thereof to the safety harness.

In a number of embodiments, the extending body includes a conduit including an extending passage therethrough which forms the open volume through which the connector can be passed. The extending body may, for example, be configured to be placed adjacent to the D-ring when the adapter is placed into the looped volume.

In a number of embodiments, the extending body includes an extending slot through which a portion of the D-ring is passed to be positioned within an extending passage formed within the extending body. In a number of embodiments, the extending body includes an extending passage which forms the open volume through which the connector can be passed.

An upper surface of the body of the adapter may be configured to support the two sections of the webbing. At least a portion of the upper surface may, for example, be concave. In a number of embodiments, the adapter further includes a first upward extending flange on a first lateral end of the portion of the upper surface and a second extending flange on a second lateral end of the portion of the upper surface.

In a number of embodiments, the adapter further includes a first extending member on a first lateral end of the portion of the upper surface and a second extending member on a second lateral end of the portion of the upper surface. Each of the first extending member and the second extending member is configured to extend laterally over at least a portion of the two sections of the webbing therebetween.

The adapter may further include at least one member extending downward from the body of the adapter which is configured to extend into at least one of the spaced slots. In a number of embodiments, the adapter further includes a first member extending downward from the body of the adapter which is configured to extend into at least one of the spaced slots and a second member extending downward from the body of the adapter which is configured to extend into another of the spaced slots.

In another aspect, a method of providing for removable connection a connector (as described above) to a safety harness includes positioning an adapter within a looped volume formed in the two sections of the webbing passing between (that is, looped through) the two spaced slots. The adapter includes an extending body adapted to maintain a volume between the two sections of the webbing extending between the two spaced slots and an upper surface of the D-shim so that a section of the connector may be positioned within or passed through the volume to removably connect the connector to the safety harness. The extending body of the adapter is formed separately from the D-shim and from the D-ring. The extending body is configured to be placed into the looped volume between the two sections of the webbing extending between the two spaced slots and an upper surface of the D-shim with the D-ring connected to the two sections of webbing extending between the spaced slots. The method may further include tightening the looped volume around the adapter after placing the adapter into the looped volume.

In a number of embodiments, the extending body includes an extending base, an extending webbing support spaced from the extending base, and an intermediate member connected between the extending base and the extending webbing support. The intermediate member may, for example, divide the open volume into a first volume on a first side of the intermediate member and a second volume on a second side of the intermediate member when the adapter is connected to the safety harness. A portion of the D-ring may be positioned within the first volume. The connector may be passed through the second volume during connection thereof to the safety harness.

In a number of embodiments, the extending body includes a conduit including an extending passage therethrough which forms the open volume through which the connector can be passed. The extending body may be configured to be placed adjacent the D-ring when the adapter is placed into the looped volume.

In a number of embodiments, the extending body includes an extending slot through which a portion of the D-ring is passed to be positioned within an extending passage formed within the extending body when the adapter is placed in connection with the safety harness. In a number of embodiments, the extending body includes an extending passage which forms the open volume through which the connector can be passed.

As described above, an upper surface of the body of the adapter may be configured to support the two sections of the webbing. At least a portion of the upper surface may, for example, be concave. In a number of embodiments, the adapter further includes a first upward extending flange on a first lateral end of the portion of the upper surface and a second extending flange on a second lateral end of the portion of the upper surface.

In a number of embodiments, the adapter further includes a first extending member on a first lateral end of the portion of the upper surface and a second extending member on a second lateral end of the portion of the upper surface. Each of the first extending member and the second extending member is configured to extend laterally over at least a portion of the two sections of the webbing therebetween.

The adapter may further include at least one member extending downward from the body of the adapter which is configured to extend into at least one of the spaced slots. In a number of embodiments, the adapter further includes a first member extending downward from the body of the adapter which is configured to extend into at least one of the spaced slots and a second member extending downward from the body of the adapter which is configured to extend into another of the spaced slots.

In a further aspect, a system includes a safety harness including webbing and a D-shim. The D-shim includes two spaced slots through which each of two sections of the webbing pass (that is are looped therethrough). The safety harness further includes a D-ring connected between the D-shim and the two sections of webbing passing between the two space slots via a connector passage of the D-ring. Each of the two sections of the webbing pass through the connector passage. The system further includes an adapter configured to form a connection with a connector (as described above). The adapter includes an extending body adapted to maintain an open volume between the two sections of the webbing extending between the spaced slots and an upper surface of the D-shim so that connector may be positioned within or passed through the open volume to removably connect the connector to the safety harness. The extending body of the adapter is formed separately from the D-shim and from the D-ring. The extending body is configured to be placed into a looped volume formed between the two sections of the webbing extending between the two spaced slots and an upper surface of the D-shim with the D-ring connected to the two sections of webbing extending between the spaced slots.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an isometric view of an embodiment of an adapter hereof.

FIG. 1B illustrates an isometric view of a system including a D-shim, D-ring and webbing of a safety harness (see FIG. 1F) as well as the adapter of FIG. 1A and a representative embodiment of a connector in the form of a pin connector, wherein the adapter and pin connector are disconnected from the D-shim and the webbing passing through the D-shim, and wherein a length (or loop) of the webbing passing through spaced slots of the D-shim has been pulled through the D-shim to form a volume through which the adapter can be passed to be placed in operative connection with the D-shim and the webbing.

FIG. 1C illustrates an isometric view of the system of FIG. 1B wherein the adapter and the pin connector are placed in operative connection with the D-shim and the webbing.

FIG. 1D illustrates a top plan view of the system of FIG. 1C, wherein the D-ring and the pin connector are not illustrated, wherein the adapter is placed in operative connection with the D-shim and the webbing.

FIG. 1E illustrates a side cross-sectional view of the system of FIG. 1C wherein the adapter of FIG. 1A and the pin connector are placed in operative connection with the D-shim and the webbing and the D-ring and pin connector are not shown.

FIG. 1F illustrates an embodiment of a safety harness including the D-shim and D-ring of FIG. 1B wherein the safety harness is illustrated flat with the adapter of FIG. 1A and a pin connector positioned to be placed in operative connection with the safety harness.

FIG. 2A illustrates an isometric view of another embodiment of an adapter hereof.

FIG. 2B illustrates an isometric view of another system hereof including a D-shim, a D-ring and webbing of the safety harness of FIG. 1F as well as the adapter of FIG. 2A and a pin connector, wherein the adapter and pin connector are disconnected from the D-shim and the webbing passing through the D-shim, and wherein a length or loop of the webbing passing through the D-shim between spaced slots thereof has been pulled through the D-shim to form a volume through which the adapter can be passed to be placed in operative connection with the D-shim and the webbing.

FIG. 2C illustrates an isometric view of system of FIG. 2B wherein the adapter and the pin connector are placed in operative connection with the D-shim and the webbing.

FIG. 2D illustrates a top plan view of the system of FIG. 2C, wherein the D-ring and pin connector are not illustrated, and wherein the adapter is placed in operative connection with the D-shim and the webbing.

FIG. 2E illustrates a side cross-sectional view of the system of FIG. 2C wherein the adapter of FIG. 2A is placed in operative connection with the D-shim and the webbing and wherein the D-ring and pin connector are not illustrated.

FIG. 3A illustrates an isometric view of another embodiment of an adapter hereof.

FIG. 3B illustrates an isometric view of another system hereof including a D-shim, D-ring and webbing of the safety harness of FIG. 1F as well as the adapter of FIG. 3A and a pin connector, wherein the adapter and pin connector are disconnected from the D-shim and the webbing passing through the D-shim, and wherein a length or loop of the webbing passing through the D-shim between two spaced slots thereof has been pulled through the D-shim to form a volume through which the adapter can be passed to be placed in operative connection with the D-shim and the webbing.

FIG. 3C illustrates an isometric view of system of FIG. 3B wherein the adapter and the pin connector are placed in operative connection with the D-shim and the webbing.

FIG. 3D illustrates a top plan view of the system of FIG. 3C, wherein the D-ring and pin connector are not illustrated, and wherein the adapter is placed in operative connection with the D-shim and the webbing.

FIG. 3E illustrates a side cross-sectional view of the system of FIG. 3C wherein the adapter of FIG. 3A is placed in operative connection with the D-shim and the webbing and wherein the D-ring and pin connector are not illustrated.

FIG. 4A illustrates an isometric view of another embodiment of an adapter hereof.

FIG. 4B illustrates another isometric view of the adapter of FIG. 4A.

FIG. 4C illustrates a side view of the adapter of FIG. 4A.

FIG. 4D illustrates another isometric view of the adapter of FIG. 4A.

FIG. 4E illustrates another isometric view of the adapter of FIG. 4A.

FIG. 4F illustrates an isometric view of another system hereof including a D-shim, D-ring and webbing of the safety harness of FIG. 1F as well as the adapter of FIG. 4A, wherein the adapter of FIG. 4A is placed in operative connection with the D-shim, the D-ring and the webbing.

FIG. 5A illustrates an isometric view of another embodiment of an adapter hereof.

FIG. 5B illustrates another isometric view of the adapter of FIG. 5A.

FIG. 5C illustrates a side view of the adapter of FIG. 5A.

FIG. 5D illustrates another isometric view of the adapter of FIG. 5A.

FIG. 5E illustrates another isometric view of the adapter of FIG. 5A.

FIG. 5F illustrates an isometric view of another system hereof including a D-shim, D-ring and webbing of the safety harness of FIG. 1F as well as the adapter of FIG. 5A, wherein the adapter is placed in operative connection with the D-shim, the D-ring and the webbing.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a flange” includes a plurality of such flanges and equivalents thereof known to those skilled in the art, and so forth, and reference to “the flange” is a reference to one or more such flanges and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

It is desirable that the connector attachments hereof be made simple and intuitive, and that connection thereof with a safety harness and connection of a connector therewith be relatively quickly accomplished for all safety harnesses. Ease of connection will promote the approved connection methodology (that is, behind the dorsal webbing) and reduce misuses. In a number of embodiments of device, methods, and system hereof, ready attachment of connectors is achieved by providing a “tunnel” adapter for use in connection with a D-shim. A number of representative embodiments hereof are discussed in connection with a pin connector including a slidable pin. However, one skilled in the art will appreciate that the adapters hereof are suitable for use with many types of connectors to be connected to the webbing of a safety harnesses without connection to the D-ring thereof. The adapters hereof are readily incorporated into new safety harnesses or retrofitted into older or previously manufactured safety harnesses which are not equipped with a tunnel for use with various connectors.

The adapter hereof is compatible with a wide variety of harnesses that do not come with a PFL tunnel. In circumstances in which, for example, a company or an individual user wishes to use a new PFL but is not ready to replace existing harness(es), an adapter hereof adds significant value by making PFLs and/or other devices using the newer pin connector more readily employable with the existing harness(es). By adding an adaptor hereof to a harness (which is a one-time process), subsequent connector attachments/detachments become simple and more intuitive. In a preliminary timed study, a proper attachment was achieved six times faster with an adapter hereof versus without such an adapter. Making the process of connector attachment faster and easier promote safer fall protection practices by, for example, reducing instances of misuse (for example, connecting a connector such as a pin connector directly to D-ring).

In a number of embodiments, the adapters hereof are formed separately from the D-shim of the safety harness. Further, the adapters hereof may be operatively connected to a D-shim with the D-ring already in operative connection with the D-shim and associated webbing. The adapters hereof include a lower (inner; in the orientation of the adapter when in operative connection with a safety harness worn by a user) surface or base which contacts an upper (outer) surface of the D-shim and an upper (outer) surface or webbing support over which the webbing of the harness passes. The adapters creates a volume, space, or passage via which a section of a connector (for example, a pin of a pin connector) can be placed in operative connection with the safety harness.

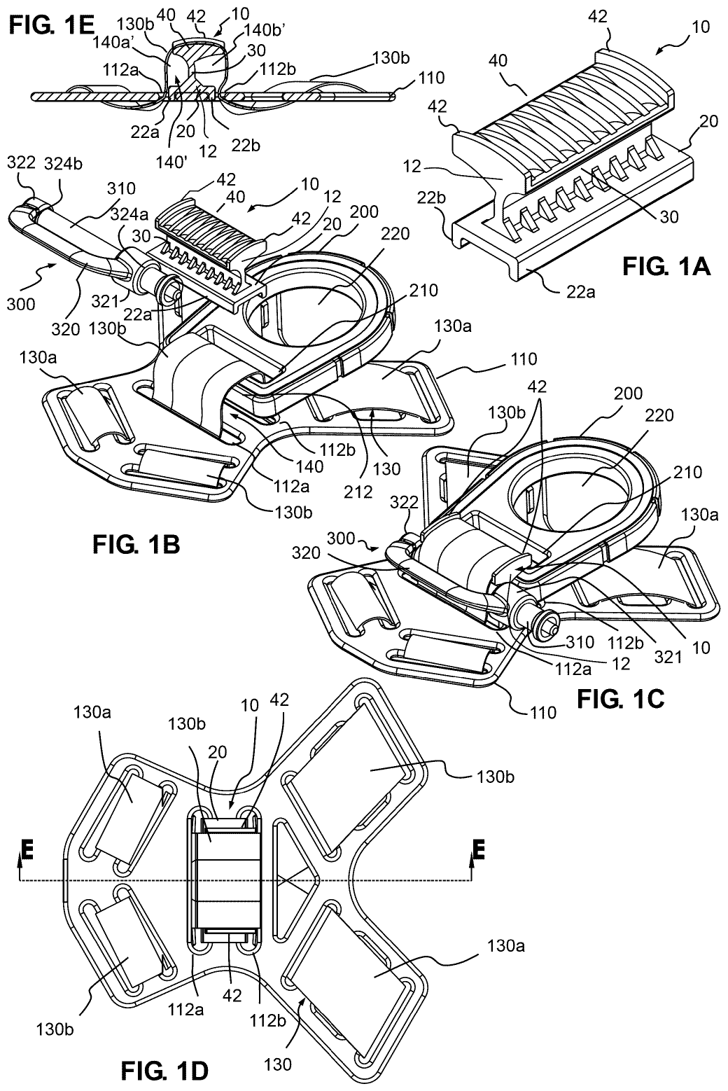

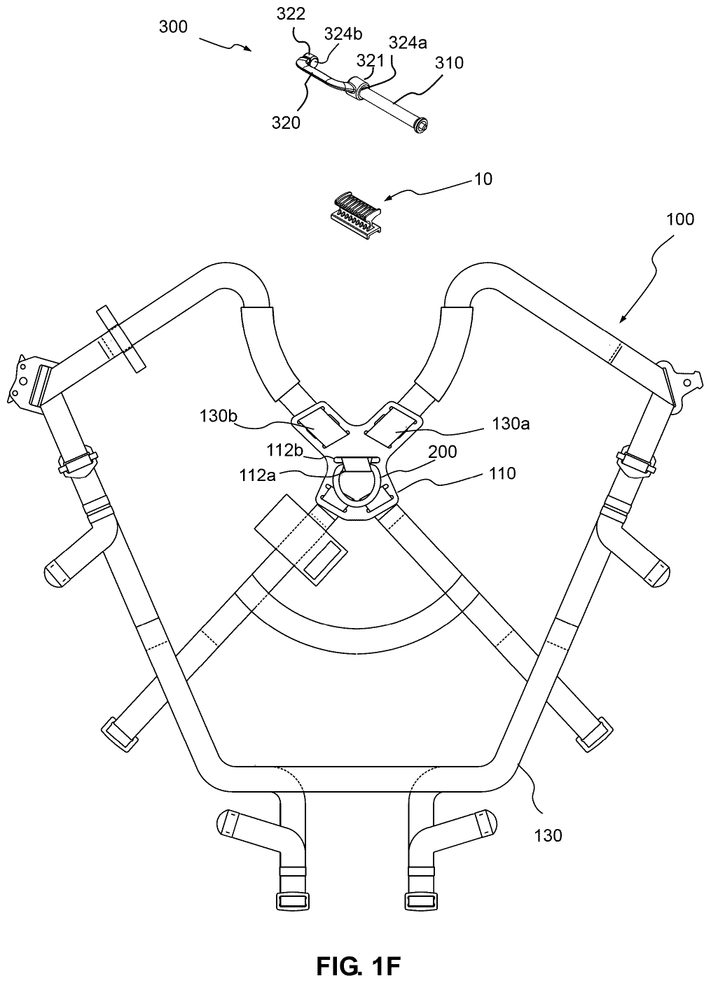

FIGS. 1A through 1F illustrate an embodiment of adapter or tunnel adapter 10 (see, for example, FIG. 1A) hereof for use with a safety harness 100. Safety harness 100 is illustrated in FIG. 1F. In FIGS. 1B through 1E, only a portion of safety harness 100 including a D-shim 110 and the portion of safety harness webbing 130 that passes through D-shim 110 are illustrated.

Representative adapter 10 includes or is formed as a (laterally) extending member or body 12 which is insertable into a volume or loop volume 140 created between D-shim 110 and webbing 130 which is, for example, created by pulling a length or loop of webbing 130 passing through space slots 112a and 112b of D-shim 110. Such spaced slots are typically, but not necessarily, positioned generally centrally on a D-shim. In FIG. 1B, webbing 130 has been pulled through space slots 112a and 112b of D-shim 110 to form loop volume 140 through which adapter 10 can be passed to be placed in operative connection with D-shim 110 and webbing 130 of safety harness 100 to laterally extend across a portion of D-shim 110. As known in the fall protection arts, two lengths or sections 130a and 130b of webbing pass through a D-shim such as D-shim 110 in an X or crossing pattern. Both sections 130a and 130b pass through central slots 112a and 112b. For simplicity and clarity, only webbing section 130b (the lower section of webbing when webbing sections 130a and 130b are passed through slots 112a and 112b) is illustrated as passing through slots 112a and 112b in FIGS. 1B through 1E. In the illustrated embodiment, the length of webbing sections 130a and 130b passing through generally central slots 112a and 112b passes through a webbing connector passage 210 of a D-ring 200 to secure D-ring 200 to safety harness 100. Not all D-rings have a dedicated webbing connector passage, and the webbing sections may pass through device connector passage 220. As known in the fall protection arts, device connector passage 220 is used for placement of a fall protection device such as an SRD in connection with safety harness 100.

Once adapter 10 is placed within volume or loop volume 140, any slack in webbing sections 130a and 130b (between slots 112a and 112b) may be tightened by pulling webbing sections 130a and 130b through the slots of D-shim 110 to secure adapter 10 in operative connection with D-shim 110 and webbing 130 of safety harness 100. The presence of adapter 10 maintains a volume 140′ between webbing 130 and an upper or outer surface of D-shim 110 which may be smaller than loop volume 140. Once adapter 10 (or another adapter hereof) is in place, a pin connector 300 can be readily connected to and removed from connection with adapter 10 (or another adapter hereof) and, thereby, with safety harness 100 as further described below using a portion retained volume 140′ (which is shared with a connective portion 212 of D-ring 200 in the illustrated embodiment as described further below). As known in the art, pin connector 300 includes a pin or extending member 310 which is slidably positioned within passages 324a and 324b of end sections 321 and 322 (see, for example, FIG. 1F) of an arced body member 320 to controllably place pin connector 300 in an open and a locked, closed state.

As, for example, illustrated in FIG. 1A, representative adapter 10 includes a laterally extending base section 20 having a lower (inner) surface or base which contacts D-shim 110. In a number of embodiments, an adapter hereof may include one or more elements or members which form a cooperating engagement or interaction with either or each of slots 112a and 112b, with webbing 130, or with D-ring 200 to stabilize the connection or position of the adapter when operatively connected to the harness. In the illustrated embodiment of FIG. 1A, adapter 10 includes one or more generally downward (with respect to the illustrated orientation) extending flanges 22a and 22b (two in the illustrated embodiment) which interact with slots 112a and 112b, respectively, to assist in stabilizing the connection formed between D-shim 110 and adapter 10. As clear to those skilled in the art, a single slot flange 22a may be provided. Embodiments with only a single slot flange 22a may, for example, be retrofittable on a wider range of D-shims (which may, for example, include different spacing between the generally central slots thereof through which both sections of webbing pass to connect with a D-ring).

Adapter 10 further include and upward (in the illustrated orientation) extending intermediate member 30 which extends from base 20 to connect to a (laterally) extending webbing support member 40, the upper (outer) surface of which supports webbing sections 130a and 130b when adapter 10 is in operative connection with safety harness 100. In the illustrated embodiment, webbing support member 40 includes upward extending flanges 42 on each lateral end thereof to create or define a seating therebetween for webbing sections 130a and 130b when adapter 10 is placed in operating connection with D-shim 110 and webbing 130 of safety harness 100 (see, for example, FIG. 1B). The lateral width of the seating is sufficient to retain the lateral width of webbing sections 130a and 130b which pass thereover.

As illustrated, for example, in FIG. 1E, adapter 10 functions to maintain at least a portion of the spaced height of webbing sections 130a and 130b (over D-shim 110) created as described in connection with FIG. 1B and the associated volume or loop volume 140. As illustrated with reference to, for example, FIGS. 1C and 1E, adapter 10 (and, in particular, extending member 30 of adapter 10) divides volume or retained volume 140′ into two open sections, open volumes or open sub-volumes 140a′ and 140b′. Connection portion or member 212 of D-ring 200 (which is not illustrated in FIG. 1E; see FIG. 1C), positioned adjacent to and partially defining passage 210, is positioned within open sub-volume 140b′, while a pin 310 of pin connector 300 is positionable within open sub-volume 140a′.

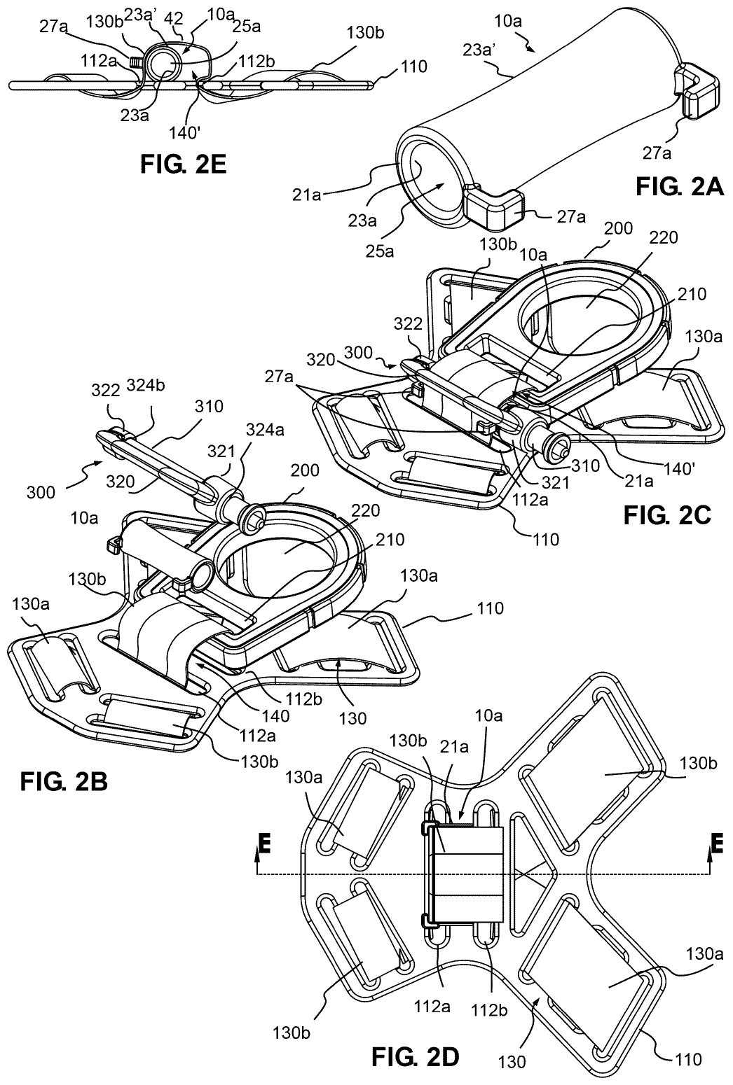

FIGS. 2A through 2E illustrate another embodiment of adapter or tunnel adapter 10a hereof for use in connection with a safety harness 100 of FIG. 1F. In general, the manner in which adapter 10a is placed in operative connection with D-shim 110 and webbing 130 of safety harness 100 is very similar to the manner in which adapter 10 is placed in operative connection with D-shim 110 and webbing 130 of safety harness 100. Referring to FIG. 2A, adapter 10a includes a conduit 21a. A radially inner surface 23a of conduit 21a forms or defines an open volume in the form of a passage 25a through which pin 310 of pin connector 300 may be passed. A radially outer surface 23a′ of conduit 21a provides a surface to contact D-shim 110 and webbing section 130b when adapter 10a is positioned within volume or space 140 (see, for example, FIGS. 2B, 2C, and 2E). In the illustrated embodiment, adapter 10a includes extending elements 27a which interact with webbing sections 130a and 130b when adapter 10a is placed within volume 140 to be in operative connection with D-shim 110 and webbing sections 130a and 130b to, for example, stabilize or secure the operative connection/position of adapter 10a with D-shim 110 and webbing sections 130a and 130b (see, for example, FIGS. 2C, 2D and 2E). In the illustrated embodiment, extending elements 27 are L-shaped to assist in capturing or encompassing a portion of webbing sections 130a and 130b.

In the illustrated embodiment, outer surface 23a′ of conduit 21a is concave. Forming at least the portion of the surface of conduit 23a as concave assists in securely seating webbing sections 130a and 130b in operative connection with adapter 10a.

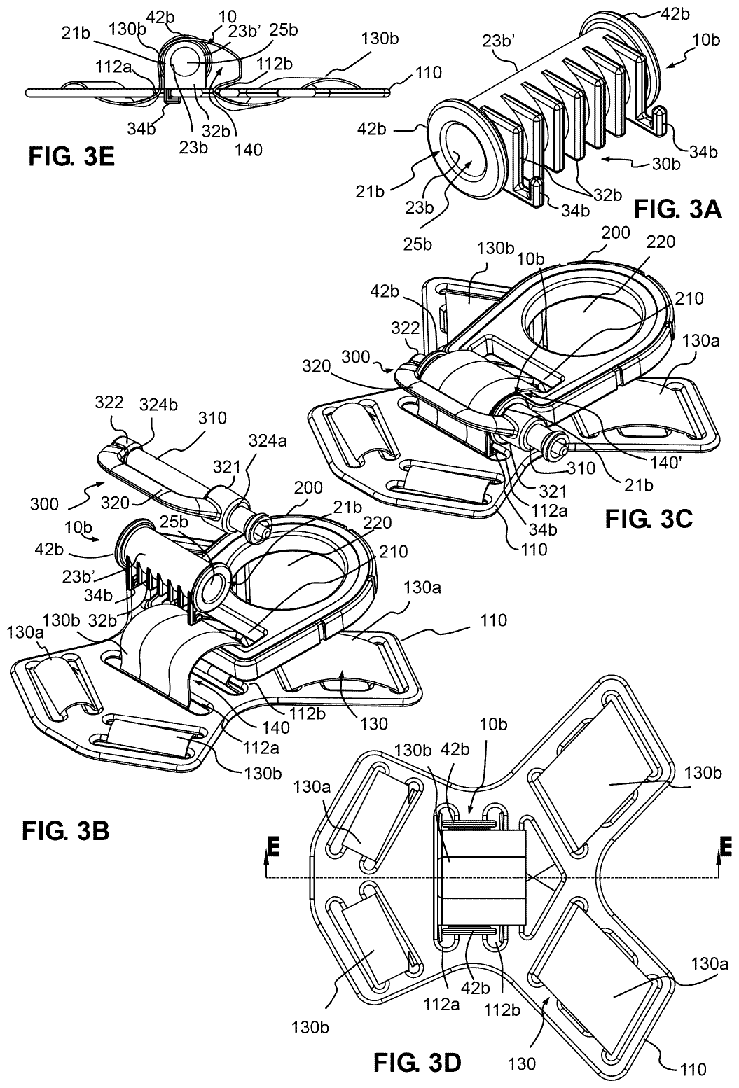

FIGS. 3A through 3E illustrate another embodiment of adapter or tunnel adapter 10b hereof for use with a safety harness 100 of FIG. 1F. In general the manner in which adapter 10b is placed in operative connection with D-shim 110 and webbing 130 of safety harness 100 is very similar to the manner in which adapter 10 is placed in operative connection with D-shim 110, webbing 130 and D-ring 200 of safety harness 100. Referring to FIG. 3A, similar to adapter 10a, adapter 10b includes a conduit 21b. A radially inner surface 23b of conduit 21b forms or defines on open volume in the form of a passage 25b through which pin 310 of pin connector 300 may be passed. A radially outer surface 23b′ of conduit 21b provides a surface to contact webbing section 130b when adapter 10b is positioned within volume or space 140 (see, for example, FIGS. 3B, 3C, and 3E). In the illustrated embodiment, adapter 10b includes a base 30b which, in the illustrated embodiment, is formed by extending members 32b. A lower or inner surface of extending members 32b contacts the upper or outer surface of D-shim 110 when adapter 10b is placed within volume 140 to be in operative connection with D-shim 110 and webbing sections 130a and 130b to, for example, stabilize or secure the operative connection of adapter 10b with D-shim 110 and webbing sections 130a and 130b (see, for example, FIG. 3E). In the illustrated embodiment, adapter 10b includes extending elements 34b which interact with slot 112a when adapter 10b is placed within volume 140 to be in operative connection with D-shim 110 and webbing sections 130a and 130b to, for example, stabilize or secure the operative connection of adapter 10a with D-shim 110 and webbing sections 130a and 130b (see, for example, FIG. 3E). In the illustrated embodiment, extending elements 34b are L-shaped and extend from a distal end of extending members 32b positioned on the lateral ends of base 30b.

In the illustrated embodiment of FIGS. 3A through 3E, the lateral ends of conduit 21b include radially outward extending flanges 42b. Flanges 42b, in connection with outer surface 23b′, form a seating which assists in securely seating webbing sections 130a and 130b in operative connection with adapter 10b.

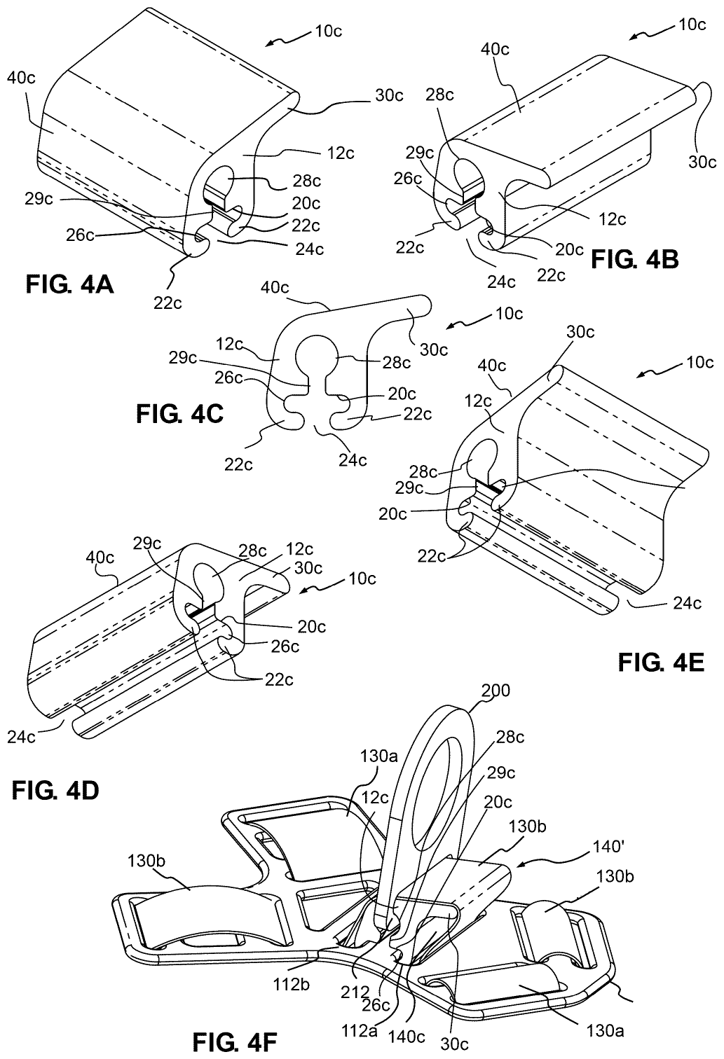

In a number of embodiments, the connection of an adapter hereof with safety harness 100 may be further stabilized via interaction of the adapter with D-ring 200. FIGS. 4A through 4F, for example, illustrate another embodiment of adapter or tunnel adapter 10c hereof for use with a safety harness 100 of FIG. 1F. In general, the manner in which adapter 10c is placed in operative connection with D-shim 110 and webbing 130 of safety harness 100 is similar to the manner in which adapter 10 is placed in operative connection with D-shim 110 and webbing 130 of safety harness 100. However, adapter 10c also forms an operative engagement or interaction with D-ring 200. Referring, for example, to FIGS. 4A to 4D, similar to adapter 10, adapter 10c includes or is formed as an extending member of body 12c which is insertable into loop 140 created between D-shim 110 and webbing 130. Body 12c includes a (laterally) extending base or base section 20c which contacts and forms connection or interaction (which is a removable or releasable connection/interaction) with D-shim 110 and also forms a removable connection with connection portion or member 212 of D-ring 200. In that regard, base section 20c includes resilient, spaced members 22c which define a space or gap 24c therebetween.

When adapter 10c is positioned within volume or space 140, connection portion or member 212 of D-ring 200 is passed through laterally extending space, slot, or gap 24c and each of members 22c is passed through one of through spaced slots 112a and 112b of D-shim 110 as illustrated in FIG. 4F. In forming the connection with D-shim 110 one of members 22c may be passed through one of spaced slots 112a as illustrated in FIG. 4F and tension/force may be applied to increase the space between members 22c so that the other of members 22c may be passed through the other of spaced slots 112a and 112b in, for example, the orientation illustrated in FIG. 4F. After members 22c are seated in spaced slots 112a and 112b, the force can be removed from adapter 10c, allowing members 22c to return to their resting position as illustrated in FIGS. 4A through 4D. The portion of D-shim 110 between spaced slots 112a and 112b will be seated or positioned within laterally extending opening or seating 26c. Connection portion or member 212 may be seated or positioned within laterally extending conduit 28c, which is connected to opening or seating 26c via a laterally extending passage 29c. The width of passage 29c may, for example, be less than the width of connection portion or member 212 to assist in maintaining connection portion or member 212 within conduit 28c

An extending or cantilevered section 30c extends from an upper (in the orientation of FIGS. 4A through 4F) section of base section 20c. When adapter 10c is placed in operative connection with D-shim 110, webbing 130 passes over upper/outer surface 40c of adapter 10c (which functions as a webbing support). Surface 40c is a curved or curvilinear surface in the illustrated embodiment. Extending section 30c functions to maintain an open volume 140c (see FIG. 4F) via which a connector such as pin connector 300 may be placed in operative connection with safety harness 100 as described above.

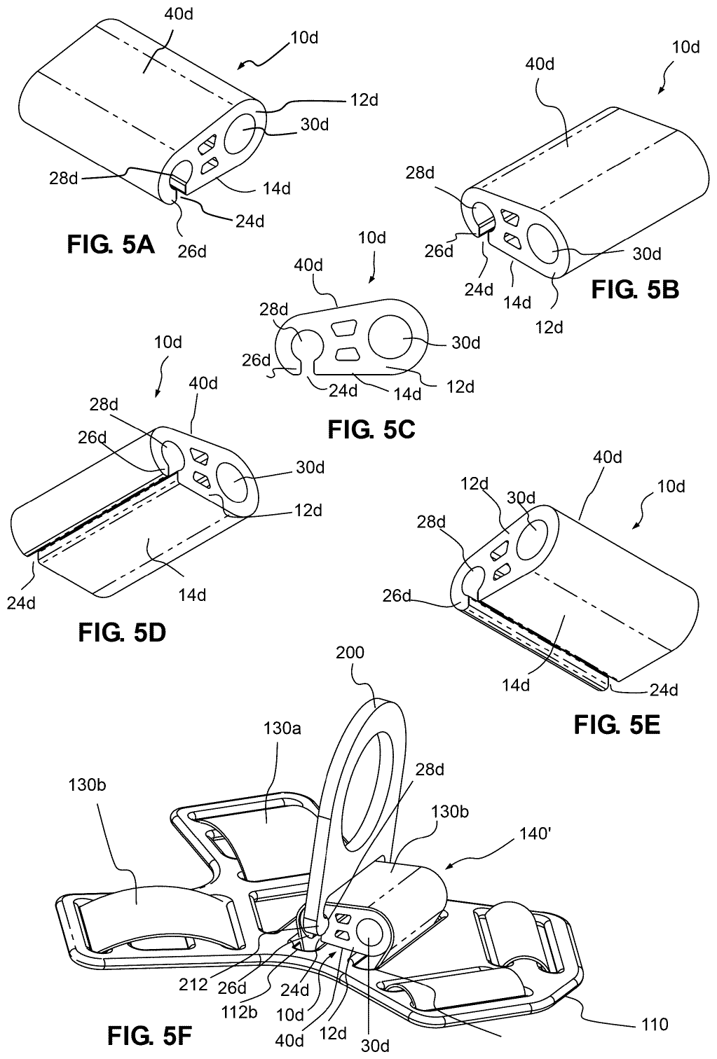

FIGS. SA through 5F illustrate another embodiment of an adapter 10d hereof which interacts (for example, via a removable or releasable connection) with D-ring 200 when placed in operative connection with safety harness 100. The manner in which adapter 10d is placed in operative connection with D-shim 110, webbing 130, and D-ring 200 of safety harness 100 is similar to the manner in which adapter 10c is placed in operative connection with D-shim 110, webbing 130 and D-ring 200 of safety harness 100. Unlike adapter 10c, however, adapter 10d does not form an engagement with slots 112a and 112b of D-shim 110. In that regard, adapter 10d includes an extending member or body 12d, having a stadium-like cross-section geometry with different radii at each longitudinal end thereof, which is insertable into loop 140 created between D-shim 110 and webbing 130. Body 12d includes a (laterally) a lower or interior surface 14d which functions as an extending base or base section which contacts D-shim 110. A laterally extending opening, slot, or gap 24d is formed in body 12d via which adapter 10d forms a operative connection or engagement (which is a removable or releasable connection or engagement) with connection portion or member 212 of D-ring 200. Opening 24d may be narrower than the width of connection portion or member 212 of D-ring 200. Section 26d may, for example, flex when force is applied in engaging D-ring 200 to widen opening, slot or gap 24d. The widening of opening, slot, or gap 24d allows passage of connection portion or member 212 of D-ring 200 therethrough to be seated in laterally extending passage or conduit 28d as illustrated in FIG. 5F. Adapter 10d further includes an open volume in the form of a laterally extending passage or conduit 30d formed therein for removable or releasable connection with a connector such as pin connector 300. Upper surface 40d of adapter 10d (which is a curved or curvilinear surface) supports webbing 130 as illustrated in FIG. 5F

In general, adapters maintain a laterally extending volume, space, or passage between an upper (outer) surface thereof, Adapters hereof may be positioned adjacent to the D-ring when placed in connection with D-shim 110 of safety harness 100 or a portion of the adapter may overhang or encompass at least a portion of the D-ring. The upper (outer) surface functions as a webbing support when the harnesses webbing is passed thereof. In embodiments of adapters hereof including conduits or passages formed in a body of the adapter, the conduit or passage need not be fully enclosed within the body of the adapter. For example, in a number of embodiment, a U-shaped or C-shaped conduit or passage with an open bottom or base to contact the upper or outer surface of D-shim 110 and an arced upper surface to contact webbing section 130a and/or 130b may be used.

After each of adapters hereof is in place (that is, in operative connection with D-shim 110 and webbing 130 of safety harness 100), a connector such as pin connector 300 can be readily connected to and removed from connection with an adapter hereof and, thereby, with safety harness 100 as described above.

Upon tightening the loop of webbing sections 130a and 130b extending between spaced slots 112a and 112b, a secure connection between an adapter hereof and D-shim 110 and webbing sections 130a and 130b of safety harness 100 is formed. Because of the manner of passages of webbing sections 130a and 130b through the slots of D-shim 110 and associated friction, the connection is unlikely to loosen. The connection of the adapters hereof with webbing 130 of the harness may be further stabilized by providing one or more upward/outward extending flanges positioned on the lateral end(s) of the webbing-supporting surface of the adapter. Further, the webbing-supporting surface may be shaped (for example, in a concave shape) to stabilize the connection. As described above, adapters hereof may further form a cooperative engagement with slots 112a or 112b of D-shim and/or with D-ring 200 to stabilize the connection thereof with D-shim 110 and harness 100. Such stabilizing functions may be used included singly or in any combination in a particular adapter.

The forces experienced by adapters hereof when in operative connection with safety harness 100, even in the case of a fall, are relatively small. The adapters hereof may be manufactured from a number of materials. In a number of embodiments, the adapters hereof are formed from a polymeric material such as SANTOPRENE® (a dynamically vulcanized polymer alloy of cured EPDM (ethylene propylene diene monomer) thermoplastic rubber available from Celanese International Corporation of Irving, Texas US) or nylon 66 (a synthetic thermoplastic polymer with an amide backbone). In a number of embodiments, bodies of adapters hereof were monolithically formed from SANTOPRENE. In a number of embodiments, an adapter hereof may, for example, be molded integrally or monolithically from such a polymer.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. An adapter for use to connect a connector to a safety harness, the connector being adapted to connect a device to the safety harness, the safety harness including webbing and a D-shim, the D-shim including spaced slots through which each of two sections of the webbing pass, a D-ring being connected via a connector passage in the D-ring to the two sections of webbing passing between the spaced slots, the adapter comprising: an extending body adapted to maintain an open volume between the two sections of the webbing extending between the spaced slots and an upper surface of the D-shim so that a section of the connector may be passed through the open volume maintained between the two sections of the webbing to removably connect the connector to the safety harness, the extending body of the adapter being formed separately from the D-shim and from the D-ring, the extending body being configured to be placed into a looped volume between the two sections of the webbing extending between the spaced slots and the upper surface of the D-shim with the D-ring connected to the two sections of the webbing extending between the spaced slots.

2. The adapter of claim 1 wherein the extending body comprises an extending base, an extending webbing support spaced from the extending base, and an intermediate member connected between the extending base and the extending webbing support.

3. The adapter of claim 2 wherein the intermediate member divides the open volume into a first volume on a first side of the intermediate member and a second volume on a second side of the intermediate member when the adapter is connected to the safety harness, a portion of the D-ring being positioned within the first volume, wherein the connector may be passed through the second volume.

4. The adapter of claim 1 wherein the extending body comprises a conduit comprising an extending passage therethrough which forms the open volume through which the connector can be passed.

5. The adapter of claim 4 wherein the extending body is configured to be placed adjacent to the D-ring when the adapter is placed into the looped volume.

6. The adapter of claim 1 wherein the extending body comprises an extending slot through which a portion of the D-ring is passed to be positioned within an extending passage formed within the extending body.

7. The adapter of claim 1 wherein the extending body comprises an extending passage which forms the open volume through which the connector can be passed.

8. The adapter of claim 1 wherein at least a portion of an upper surface of the extending body of the adapter is configured to support the two sections of the webbing.

9. The adapter of claim 8 wherein at least a portion of the upper surface is concave.

10. The adapter of claim 8 further comprising a first upward extending flange on a first lateral end of the portion of the upper surface and a second extending flange on a second lateral end of the portion of the upper surface.

11. The adapter of claim 8 further comprising a first extending member on a first lateral end of the portion of the upper surface and a second extending member on a second lateral end of the portion of the upper surface, each of the first extending member and the second extending member being configured to extend laterally over at least a portion of the two sections of the webbing therebetween.

12. The adapter of claim 1 further comprising at least one member extending downward from the extending body of the adapter which is configured to extend into at least one of the spaced slots.

13. The adapter of claim 1 further comprising a first member extending downward from the extending body of the adapter which is configured to extend into at least one of the spaced slots and a second member extending downward from the extending body of the adapter which is configured to extend into another of the spaced slots.

14. A method of providing for removable connection of a connector to a safety harness, the connector being adapted to connect a device to the safety harness, the safety harness including webbing and a D-shim, the D-shim including two spaced slots through which each of two sections of the webbing pass to connect to a D-ring via a connector passage in the D-ring, the method comprising: positioning an adapter within a looped volume formed in the two sections of the webbing passing between the two spaced slots, the adapter comprising an extending body adapted to maintain an open volume between the two sections of the webbing extending between the two spaced slots and an upper surface of the D-shim so that the connector may be passed through the open volume to removably connect the connector to the safety harness, the extending body of the adapter being formed separately from the D-shim and from the D-ring, the extending body being configured to be placed into the looped volume between the two sections of the webbing extending between the two spaced slots and an upper surface of the D-shim with the D-ring is connected to the two section of webbing extending between the two spaced slots.

15. The method of claim 14 further comprising tightening the two sections of the webbing over the adapter after placing the connector into the looped volume.

16. The method of claim 15 wherein the extending body comprises an extending base, an extending webbing support spaced from the extending base, and an intermediate member connected between the extending base and the extending webbing support.

17. The method of claim 16 wherein the intermediate member divides the open volume into a first volume on a first side of the intermediate member and a second volume on a second side of the intermediate member when the adapter is connected to the safety harness, a portion of the D-ring being positioned within the first volume, and wherein the connector is passed through the second volume.

18. The method of claim 15 wherein the extending body comprises a conduit comprising an extending passage therethrough which forms the open volume through which the connector can be passed.

19. The method of claim 18 wherein the extending body is configured to be placed adjacent the D-ring when the adapter is placed into the looped volume.

20. The method of claim 15 wherein the extending body comprises an extending slot through which a portion of the D-ring is passed to be positioned within an extending passage formed within the extending body when the adapter is placed in connection with the safety harness.

21. The method of claim 15 wherein the extending body comprises an extending passage which forms the volume through which a connector can be passed.

22. A system, comprising:
a safety harness comprising webbing and a D-shim, the D-shim including two spaced slots through which each of two sections of the webbing pass, the safety harness further comprising a D-ring connected between the D-shim and the two sections of webbing passing between the two space slots via a connector passage of the D-ring, each of the two section of the webbing passing through the connector passage, and
an adapter configured to form a connection with a connector, the connector being adapted to connect a device to the safety harness, the adapter comprising an extending body adapted to maintain an open volume between the two sections of the webbing extending between the two spaced slots and an upper surface of the D-shim so that the connector may be passed through the volume to removably connect the connector to the safety harness, the extending body of the adapter being formed separately from the D-shim and from the D-ring, the extending body being configured to be placed into a looped volume between the two sections of the webbing extending between the two spaced slots and an upper surface of the D-shim with the D-ring connected to the two section of webbing extending between the two spaced slots.
